(19) United States
(12) Patent Application Publication
(10) Pub. No.: US 2021/0233380 A1
(43) Pub. Date: Jul. 29, 2021

(54) TEXT MESSAGE CAPABLE ALARM SYSTEM

(71) Applicant: Mitch Reitman, Fort Worth, TX (US)

(72) Inventor: Mitch Reitman, Fort Worth, TX (US)

(21) Appl. No.: 16/773,125

(22) Filed: Jan. 27, 2020

(51) Int. Cl. G08B 25/00; G08B 25/10; G08B 25/08; H04W 4/14

(52) U.S. Cl. CPC G08B 25/007; H04W 4/14; G08B 25/08; G08B 25/10

(57) ABSTRACT

The present disclosure is directed to a text or SMS enabled alarm system. The system, or method for signal transformation having at least one sensor capable of producing at least one trigger signal. The at least one trigger signal capable of being transmitted over at least one communication network to a computing device that monitors the sensors. A computing device can be coupled to the at least one communication network for receiving and/or sending the trigger signal. At least one transmission service unit can also be coupled to the computing device for transmitting a notice or status signal created by the computing device, in a text or SMS format. The computing device coupled to at least one text to DTMF conversion unit, and the DTMF conversion unit being configured to converting a DTMF signal into a text or SMS message for transmission via the at least one transmission service.

### BACKGROUND

### Technical Field

The present disclosure relates to alarm systems. More particularly, and not by way of limitation, the present disclosure is directed to an apparatus, system or method for converting dial tone messages into text or SMS messages.

### Description of Related Art

Alarm systems have utilized dial tone, or multi-frequency dial tone messaging for many years. However, with increases in wireless or cellular technology many houses and businesses no longer have a landline or hardwire connection to a network. Additionally, the cost of a wireless or cellular network connection for transmitting dial tones can be expensive and require costs of $20 or more a month just to have it available even if it is not used. Accordingly, it would be advantageous to have an apparatus, system or method that overcomes the disadvantages of the prior art.

### BRIEF SUMMARY

The present disclosure is directed to a text or SMS enabled alarm system.

Thus, in one aspect, the present disclosure is directed to a system for signal transformation having at least one sensor capable of producing at least one trigger signal. The trigger signal(s) capable of being transmitted over at least one communication network. A computing device can be coupled to at least one communication network for receiving and/or sending the trigger signal(s). At least one transmission service unit can also be coupled to the computing device for transmitting a notice or status signal created by the computing device, in a text or SMS format.

In another aspect, the present disclosure is directed to a method for signal transformation. The method includes monitoring at least one sensor via a communication network. The sensor(s) allowing for the creation of a trigger signal that is capable of being received by a computing device. The computing device capable of creating a notice signal and transmitting the notice signal as a text or SMS message to a receiving station using at least one transmission service. The receiving station configured to receive the notice signal and convert it into a DTMF signal for use by the receiving station.

In yet another aspect, the present disclosure is directed to a system for signal transformation having at least one receiving unit coupled to at least one transmission service. The receiving unit being connected to at least one computing device by the transmission service(s), and the computing device being coupled to at least one text to DTMF conversion unit. The DTMF conversion unit is capable of converting a DTMF signal into a test or SMS message for transmission via the at least one transmission service.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a block diagram illustration of an alarm monitoring system.

FIG. 2 is a block diagram illustration of an alarm monitoring system.

FIG. 3 is a block diagram illustration of an alarm panel or computing device.

FIG. 4 is a block diagram illustration of a computing device and a conversion unit.

FIG. 5 is a block diagram illustration of a conversion unit.

FIG. 6 is a block flow diagram illustration of an alarm monitoring system.

FIG. 7 is a flowchart illustration of an alarm monitoring system.

FIG. 8 is a flowchart illustration of signal operations of an alarm monitoring system.

FIG. 9 is a flowchart illustration of an alarm monitoring system and alarm monitoring signal chain.

### DETAILED DESCRIPTION

An embodiment of the disclosure will now be described. Home alarm systems have a history of providing peace of mind to many individuals and businesses. However, with the ever increasing number of individuals seeking to cut costs and expenses who are cutting the cord, or moving to a life without telephone lines or landlines there is the issue of how an alarm system will communicate with central receiving or monitoring stations. While cellular or wireless transmission systems can allow for communication without a landline, these units require a constant service plan that can add up to hundreds of dollars a year for an individual or business on top of the service and monitoring fees for the alarm system. Thus, there is a need for an apparatus, system, or method that is capable of replacing a telephone line or landline for an alarm system while reducing the overall costs.

The apparatus, system, or method would need to provide a cost savings over current wireless systems while also providing a simple replacement of current systems. One possible way to achieve this is by replacing and/or modifying current wireless systems, many that rely on 3G technology that is being phased out, with a system that utilizes 4G and/or 5G technologies and sends brief or short text messages to provide the necessary information. An apparatus, system, or method that replaces telephone lines would also need to provide a Dual Tone Multi-Frequency (DTMF) response that traditional alarm systems have come to rely on, without sacrificing significant time and speed. These systems would also need to have some form of redundancy built in to allow for confirmation of signals and proper alert settings.

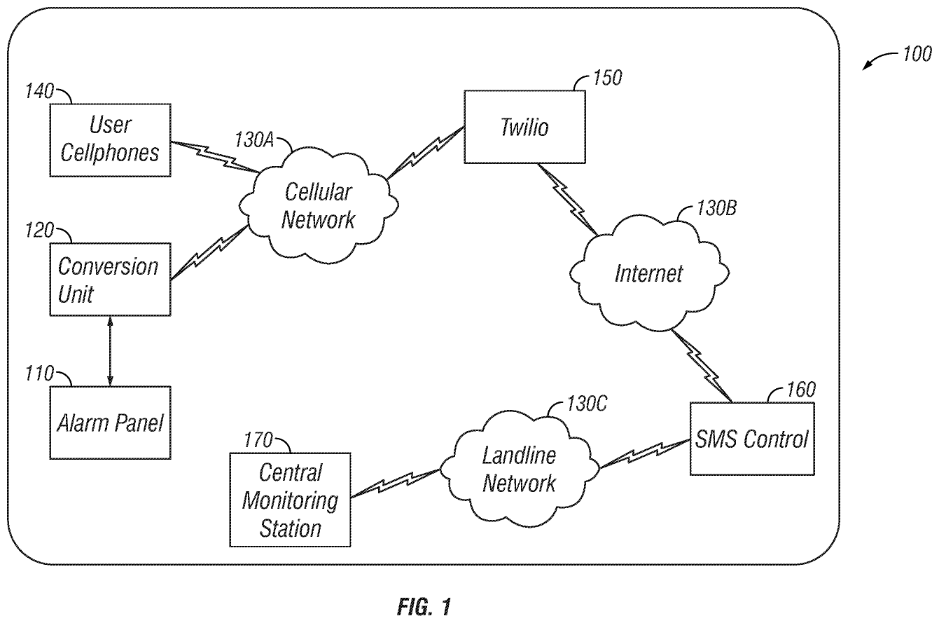

FIG. 1 is a block diagram illustration of an alarm monitoring system 100 that allows for the communication of alerts and/or other signals to through at least one transmission service 130A, 130B, and/or 130C to a receiving station 160 and/or monitoring station 170. The alarm monitoring system 100, in at least one embodiment, includes an alarm panel 110 and a conversion unit 120 coupled to the alarm panel 110. In at least one example, the alarm panel 110 is and/or includes a computing device (not illustrated). The conversion unit 120 can allow for a DTMF signal to be converted to a Short Messaging Service (SMS) or text message. In at least one example, a corresponding conversion unit and/or software may be utilized by a receiving station 160 and/or monitoring station 170.

The conversion unit 120 can include the ability to receive DTMF tones from the alarm panel 110 and/or to send DTMF tones back to the alarm panel 120. The conversion unit 120, in at least one embodiment, may also transmit over a transmission service 130A, 130B, and/or 130C (collectively transmission services 130). In at least one example, the transmission service 130A may be a cellular network such as but not limited to, 3G, 4G, 5G, LTE or other transmission protocol or standard, and/or combinations thereof. Further to this example, transmission service 130B may include an internet protocol such as, but not limited to, Dial-up, DSL, fiber optics, cable, Local Area Networks, Wireless Local Area network, or other protocols for providing access to internet services, and/or combinations thereof. An additional example, transmission service 130C can include a traditional telephone line and/or landline. It would be understood, that to fully transmit a signal from point A to point B, a multitude of transmission services may be utilized while in other examples a single transmission service may be utilized for the entire transmission.

For example, the alarm panel 110 through the conversion unit 120 may communicate to a user device 140. In at least one embodiment, the user device 140 is a cellular phone, mobile device, tablet, laptop, mobile computer, and/or other device capable of receiving and/or sending a communication signal. In at least one example, the conversion device 120 would use the transmission service 130A or a cellular network to transmit a signal and/or message to a user device 140. Further to this example, a user (not illustrated) may utilize a user device 140 to send signals and/or messages to the alarm panel 110 through the conversion unit 120.

A communication service 150 may be utilized to create, generate, and/or modify shorthand signals into full messages and/or decipherable messages. In at least one example, a signal is transmitted from the alarm panel 110 through the conversion unit 120 over the transmission service 130A to the communication service 150 that can then use one or more of the transmission services 130 to communicate the signal to a receiving station 160 and/or monitoring station 170. In at least one example, the communication service 150 is a messaging service such as but not limited to Twilio, Teli, SignalWire, Nexmo, Plivo, and/or Sinch, or other services capable of sending and/or receiving SMS messages or text messages. In at least one embodiment, the communication service 150 may provide conversion and/or transmission of a signal over an alternative transmission service to a receiving station 160 and/or a monitoring station 170. In at least one example, a receiving station 160 may be a routing station, conversion station, regional station, and/or substation to assist a monitoring station 170. A monitoring station 170, in at least one embodiment, may provide dispatch and/or communication services to law enforcement, first responders, and/or users.

In at least one embodiment, the receiving station 160 may be a conversion station that allows for the SMS messages to be converted to DTMF tones that are sent to the monitoring station 170. As an example, an alert signal is triggered by the alarm panel 110. The alarm panel 110 then sends out a signal that is received by the conversion unit 120. The conversion unit 120 converts the signal into a SMS message that is sent via a transmission service 130A to a communication service 150 that allows for the transmission of the SMS via a second transmission service 130B to a receiving station 160 that converts the SMS message back into a signal that is transmitted over a third transmission service 130C to a monitoring station 170.

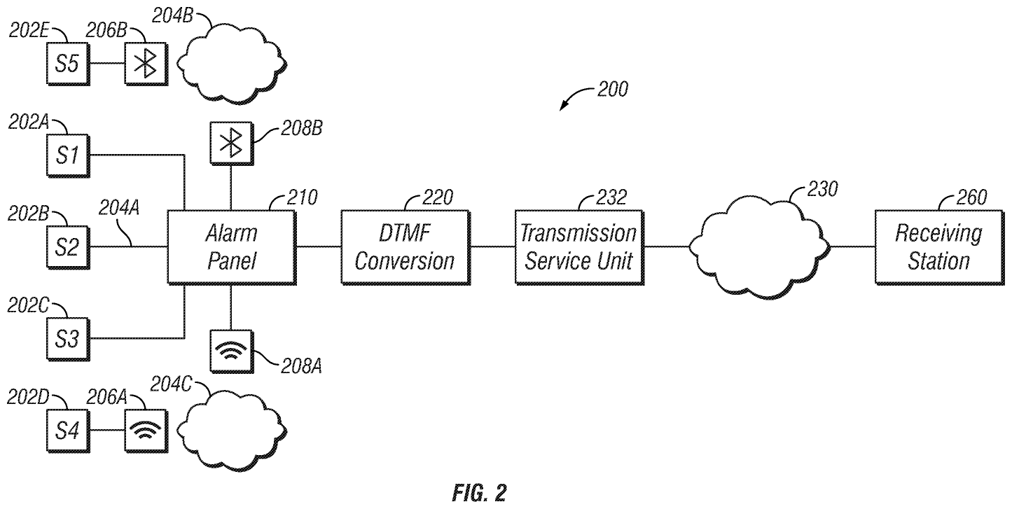

FIG. 2 is a block diagram illustration of an alarm monitoring system 200. The alarm system 200 allows for the communication signals from a sensor 202A, 202B, 202C, 202D, and/or 202E (collectively sensors 202) to a receiving station 260. In at least one embodiment, the sensors 202 are connected to an alarm panel 210 that can send and/or receive signals of multiple types. The signals may be sent through a conversion unit 220 that allows for communication of the signal as a text message through a transmission service unit 232. The transmission service unit 232 allows for the transmission of the signal over a transmission service 230 to the receiving station 260.

The alarm panel 210 can receive and/or send signals to sensors 202 through panel transceiver(s) 208A and/or 208B (collectively panel transceivers 208). In at least one example, the sensors 202 may receive signals to trigger and/or begin certain operation such as but not limited to, armed mode, disarmed mode, alert mode, sleep mode, safe mode, open mode, closed mode, wet mode, dry mode, sound mode, motion mode, and/or other modes for the specific type of sensor 202. For example, the sensors 202 may include door, motion, water, sound or break, magnetic, position, accelerometer, sensors and/or other types of sensors for specific operations. In at least one embodiment, the sensors 202 include sensor transceivers 206A and/or 206B (collectively sensor transceivers 206). The sensor transceivers 206 can allow for the communication of signals, alerts, and/or modes of the sensor(s) 202 to an alarm panel 210.

In at least one embodiment, the sensors 202 have a battery and a set of circuit components that allow for the creation, and/or receipt of signals, alerts, and/or modes. In at least one example, the set of circuit components may include the sensor transceiver 206, a computing device (not illustrated), and/or various circuit components such as resistors, capacitors, packaged chips, op-amps, digital logic chips, inductors, wiring, contacts, printed circuit boards, and/or similar components.

The sensor transceivers 206 may include a wireless local area network (WLAN) sensor transceiver 206A and/or a Bluetooth or Zigbee sensor transceiver 206B, and/or a combination of transceivers with various communication protocols. For example, a sensor 202A may be a door sensor that allows for a signal or alert when a door is opened or closed, in some examples the mode of the sensor 202A may limit what signals may be sent. A sound or break sensor 202B may be utilized in rooms with large number of windows, to alert the alarm panel 210 when a sound or glass break has occurred. The sound or break sensor 202B may also receiving signals, alerts or modes to allow it to reduce the number of events occurring. A motion sensor 202C can be utilized to know when a person, or other object is moving within a monitored area. Similar to the sound or break sensor 202B, the motion sensor 202C may also receiving and/or send signals, alerts, and/or modes to or from the alarm panel 210. A water sensor 202D can allow for the detection of water leaks or appliance malfunctions. The water sensor 2002D can also, in at least one example, send or receive signals, alerts, and/or modes to or from the alarm panel 210. A smoke alarm 202E may also be included in the alarm system 200 for the detection of any fire related events. Much like all of the sensors 202, the smoke alarm 202E can also send to or receive from the alarm panel 210 signals, alerts, and/or modes.

The sensors 202 may communicate over communication systems 204A, 204B, and/or 204C (collectively communication systems 204). The communication systems 204 can include, but are not limited to a wired communication system 204A, a wireless network communication system 204B, and/or a Bluetooth or Zigbee communication system 204C. The wired communication system 204A may allow for a direct connection between a sensor 202A, 202B, and/or 202C and the alarm panel 210. The wireless network communication system 204B can allow for communication over a wireless local area network (WLAN) and/or Internet Protocol communication. The Bluetooth or Zigbee communication system 204C can allow for a Bluetooth or Zigbee (IEEE 802.15.4) signal to be transmitted and/or received by a sensor 202 or alarm panel 210.

The communication systems 204 an allow for the sensors 202 and the alarm panel 210 to communicate over one or more communication system 204. In at least one embodiment, the sensors 202 may be connected to the alarm panel 210 through at least two communication systems 204. This redundancy while currently not found in many home based system, can be found in business and/or enterprise alarm systems.

At the heart of any alarm system 200 is the alarm panel 210. The alarm panel 210 processes and/or interprets many different signals, alerts, and/or modes. Signals may be statuses of various sensors and/or communications systems, while alerts may be events or signals triggered by events that occur near or at the sensor, and modes may allow for certain signals or alerts to be ignored and/or avoided. For example, in a disarmed or safe mode the alarm panel 210 may ignore door open and/or door closed signals from a sensor 202A or other signal, while a smoke alarm 202E and/or a water sensor 202D may still cause an alarm to be generated by the alarm panel 210. When an alarm is triggered the alarm panel 210 will attempt to communicate the alarm to a receiving station 260 (in at least one example, may also be a monitoring station). The alarm signal, that is comprised of DTMF signals, is transmitted to the conversion unit 220 that converts the DTMF signals into a SMS or text message. In at least one embodiment, the conversion unit 220 returns an answer tone to the alarm panel 210. Many alarm panel(s) require an answer tone in order to cease sending the alert and/or alarm signal. Thus, having a conversion unit 220 that allows for the return of an answer signal allows for the control or interaction with the alarm panel 210.

The conversion unit 220 may then connect to a transmission service unit 232 and/or a transmission service 230. In at least one embodiment, the conversion unit 220 may communication with two or more transmission service units 232 and/or two or more transmission services 230. The transmission service unit 232 may in at least one example, be incorporated within the transmission service 230. For example, the transmission service unit 232 may be a modem, and/or router that allows for connection from the alarm panel 210 to a receiving station 260. The transmission service unit 232 may be utilized to transmit a signal in the proper manner. For example, a telephone transmission may utilize a packet based transmission system and the transmission service unit 232 can perform the desired packet preparation before transmission over the transmission service 230. In at least one example, a second transmission service unit may be found at the receiving station 260. The receiving station 260 can be, in at least one embodiment, a monitoring station or other station for conversion or dispatching.

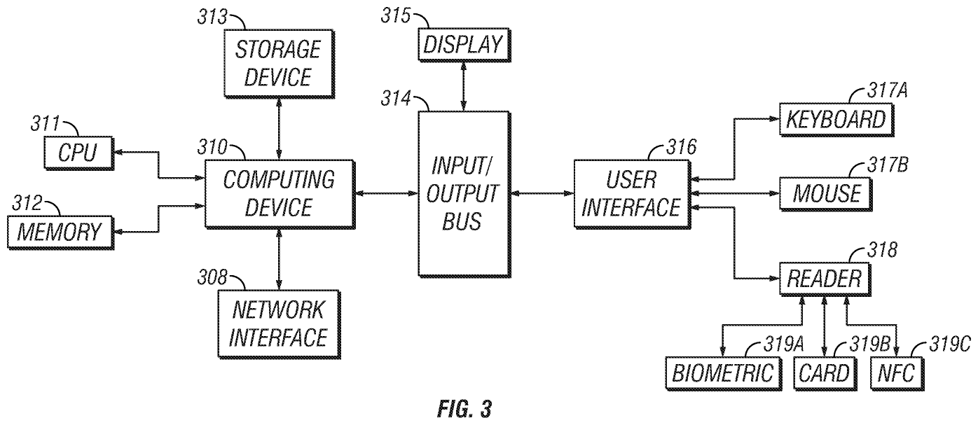

FIG. 3 is an illustration of an alarm panel or computing device 310 and additional components that are capable of being coupled to the alarm panel or computing device 310. In at least one embodiment, the computing device 310 may also be utilized with additional components or in additional areas of an alarm system. The computing device 310 can allow for the processing and/or logical control of a set of inputs and/or outputs.

The computing device 310 in at least one embodiment, includes a central processing unit (CPU) 311, memory 312, at least one storage device 313, and/or a transceiver (network interface) 308. It would be understood that these components may be individual units or a set of units capable of being coupled together. In at least one example, the computing device 310 may be coupled to an Input/output Bus 314. The input/output bus 314 can allow for additional signals and/or devices to be coupled to the computing device 310. For example, the input/output bus 314 can allow for the coupling of other components, and/or devices such as, but not limited to, a display 315, and/or a user interface 316 that may include a keyboard 317A, a mouse 317B, and/or a readable device 318 such as a biometric reader 319A, a card reader 319B, and/or a Near Field Communication reader 319C, and/or a combination thereof. It would be understood that a readable device 318, and/or user interface 316 may also include improvements or other devices know and/or developed in the future.

These components and/or devices can allow for the computing device 310 to process information, data, and/or signals for control and/or operations. For example, when the computing device 310 is operated in an alarm panel configuration it can receive and send signals through the transceiver 308. These signals can then be processed with the CPU 311, and/or stored in memory 312 or storage device 313. The computing device 310 may also provide a visional indication and/or alert via the display 315. A user interface 318 may allow for the connection of devices such as a keyboard, and/or mouse for additional interactivity with the computing device 318.

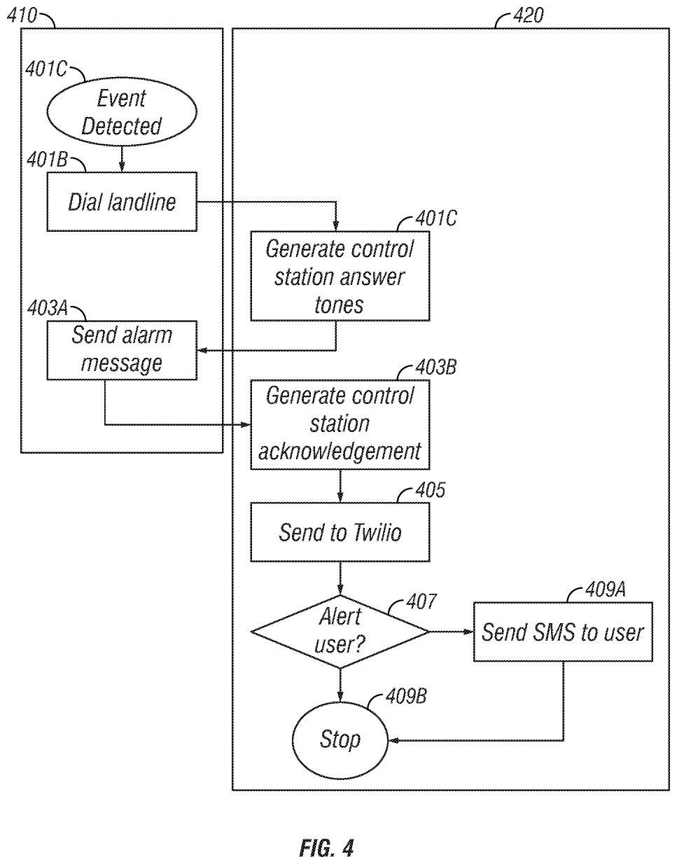

FIG. 4 is an illustration of a computing device 410 (configured as an alarm panel) and a conversion unit 420. The alarm panel 410 can be coupled to sensors that allow for alarm events to be detected 401C. The detected event 401C can then be transmitted via a transceiver unit. The transceiver unit may in at least one embodiment, be a landline or cellular transmission means. The transceiver unit can dial the landline or other transmission means 401B to connect with a receiving or monitoring station. However, in the present disclosure, the transmitted signal that is in DTMF tones is intercepted by a conversion unit 420.

The conversion unit 420 can generate monitoring and/or receiving station answer tones 401C to return to the computing device 410. The computing device 410 may then send an alarm message 403A through the transmission unit (not illustrated). The alarm message can then be intercepted by the conversion unit 420, that can generate a text or SMS message from the alarm message 403B. It would be understood that the alarm message may also be an alert or activity notice and is not limited to only alarm messages. In at least one example, a communication service (not illustrated) may be utilized to transmit the text or SMS message. In some examples, a transmission service may be utilized individually, and/or in conjunction with the communication service to transmit the text or SMS message. The text or SMS message can be sent to and/or over the communication service 405 from the conversion device 420. The conversion unit 420 may also alert a user 407 about an event, alarm, and/or activity detected by the sensors and/or the computing device 410. A test or SMS message may be sent to the user 409A. In at least one example, the user may select and/or provide preferences of the events, alerts, and/or alarms that they desire to receive, these may be loaded into the computing device 410 and/or the conversion unit 420. If the user has not set the preference for receiving messages and/or the message has been sent, the transmission process may be stopped 409B. In at least one embodiment, the transmission process may include acknowledgements and/or other user commands that are received by the conversion unit 420 and/or computing device 410. It would be understood that while describing a process for sending a message via text or SMS, the conversion unit 420 and/or computing device 410 may also receive text or SMS messages as well.

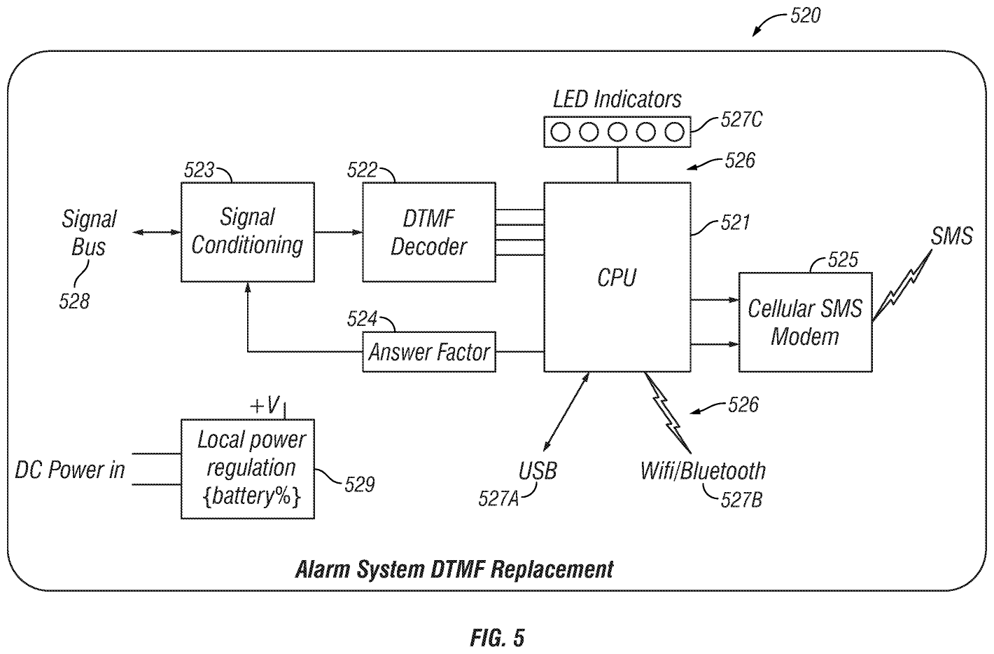

FIG. 5 is an illustration of a conversion unit 520. The conversion unit 520 can receive signals at a signal bus and/or interface bus 528, that is then processed by a CPU 521. In at least one example, the conversion unit 520 may also include a computing device that utilizes a CPU 521 or other logic or processing unit or system. The conversion unit 520 can also send a text or SMS message through a cellular modem 525.

The conversion unit 520 receives signals, alerts, and/or alarms at a signal or interface bus 528. In at least one embodiment, the signal or interface bus 528 is configured and/or capable of receiving a DTMF signal and/or transmission. In some examples, the signal may be conditioned with a signal conditioning unit or circuit 523. After conditioning the signal may be decoded with a decoder unit or circuit 522. The decoded signal can then be processed and/or converted to a text or SMS message by the CPU 521 for transmission by the cellular modem 525. In at least one example, an answer DTMF tone or signal 524 may be created and/or factored into the signal condition unit or circuit 523. The answer DTMF tone or signal 524 may be transmitted from the signal or interface bus 528.

In at least one example, the CPU 521 may be connected to an input/output bus 526. The input/output bus 526 allows for the connection of indicators 527C, user interface devices 527A, and/or transceivers 527B. In some embodiments, the indicators 527C, user interface devices 527A, and/or transceivers 527B may also be coupled directly to the CPU 521 or other computing device. The CPU 521, other components and/or circuits may also receive power from a power system 529.

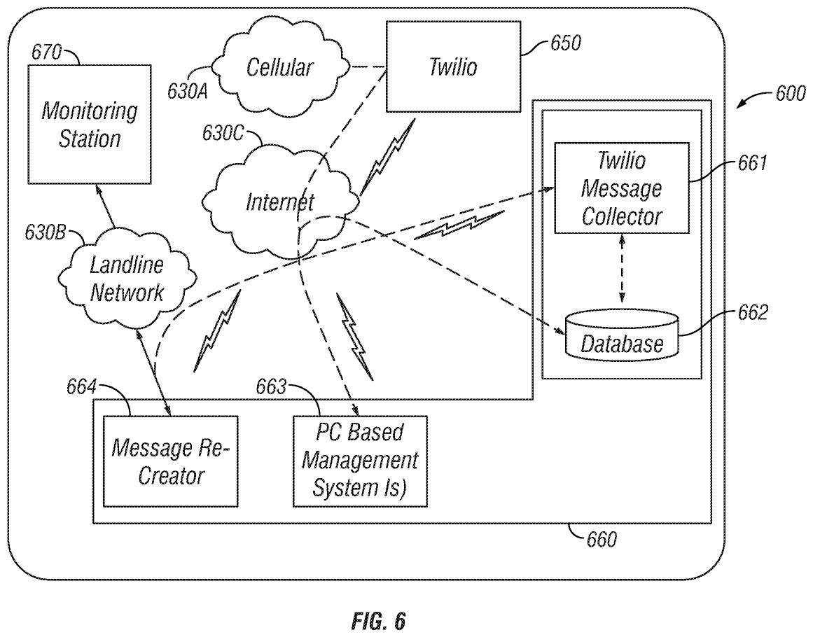

FIG. 6 is an illustration of an alarm monitoring system 600. The alarm monitoring system 600 can allow for receipt of a text or SMS message through a communication service 650 and/or through a transmission services such as but not limited to a transmission service 630A or a cellular network. The communication service 650 may also communicate through a transmission service 630B or an Internet Protocol (IP). The text or SMS message can then be sent to a management system 663. In at least one example, the management system 663 may utilize a computing device to perform processing and/or operations. The management system 663 may access a message database 662 and/or message collator system 661.

The message database 662 and/or message collector 661 can allow for text or SMS messages to be converted into DTMF tones by a message recreator system 664. For example, the receiving station 660 may receive alarm signals for several different services that utilize slight variations of the DTMF tones for different alarm monitoring companies. Thus, a message database 662 and/or message collector 661 can allow for each message (signal) to be collected for each monitoring service. The message recreator 664 can then create a DTMF tone signal that can be transmitted over a transmission service 630C or a landline communication system to a monitoring station 670.

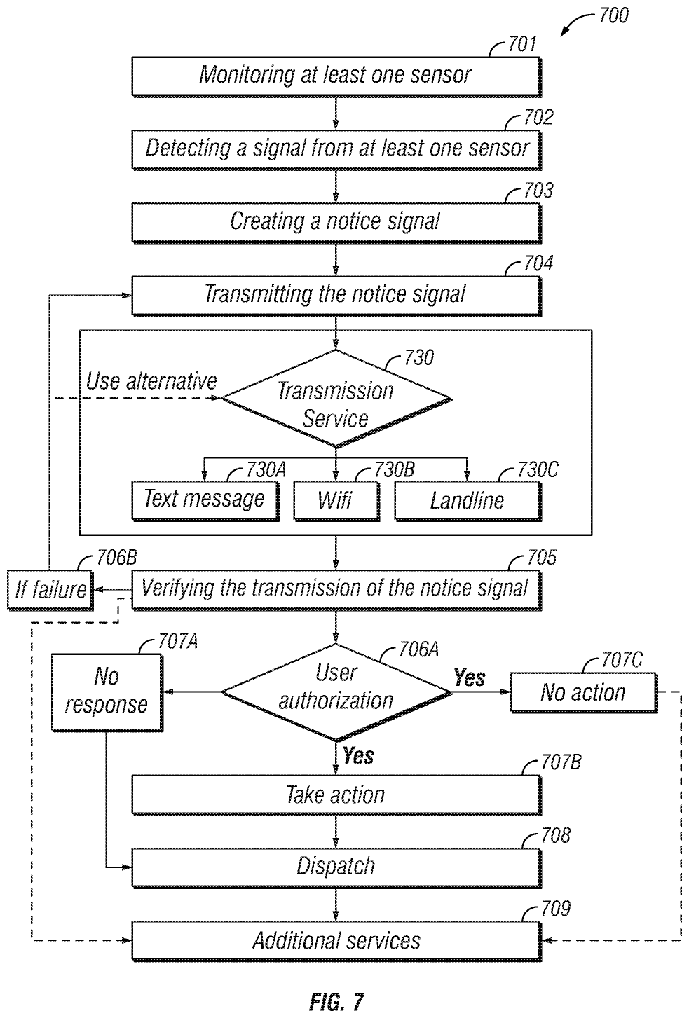

FIG. 7 is a flowchart illustration of an alarm monitoring system 700. The alarm monitoring system 700 can include at least one sensor that is coupled to an alarm panel and/or computing device (not illustrated). An alarm panel can be monitoring the at least one sensor 701 in various different conditions and/or settings. A signal can be detected from the at least one sensor 702 by the alarm panel through a wired and/or wireless connection. The alarm panel or computing device can create a notice signal 703. The notice signal can be transmitted 704 by the alarm panel through a transceiver or other communication system or means. In at least one embodiment, a transmission service can be chosen 730 from a set of transmission services. For example, a text messaging service 730A, an internet protocol 730B, and/or a landline 730C. In at least one embodiment, a conversion unit may be utilized to generate the proper message for the transmission service or unit.

The notice signal may then be verified 705. If there is a failure 706B, then an alternative transmission service may be utilized to transmit the notice signal 704. If the notice signal is transmitted successfully, the alarm monitoring system 700 may then include a user authorization message 706A. If a user authorization message 706A is included, there may be no response 707A, a take action request 707B, and/or a no action response 707C. For example, a parent may desire to monitor when a child gets home from school and accordingly would use the no action response 707C rather than requesting a specific action to be taken. If a take action request 707B is received then a dispatch 708 can be created to alert local emergency or law enforcement personal. A dispatch 708 may also occur is there is an alarm condition notice signal in a no response 707A condition. After dispatch additional services 709 may also be provided. These additional services 709 may include alerts for low batteries, sensor conditions, weather conditions, internet of things notifications, and/or other communications.

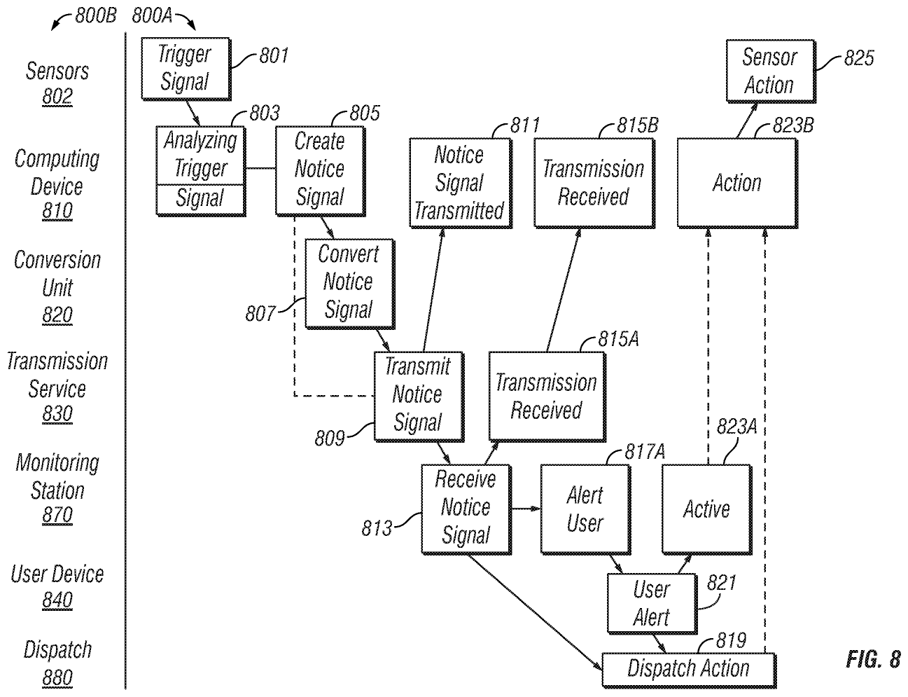

FIG. 8 is a flowchart representation of signal operations of an alarm monitoring system 800A. The illustration includes alarm monitoring system 800A, and alarm monitoring event and/or signal chain 800B. For example, an alarm monitoring system 800A can have one or more sensors 802, these sensors 802 allow for events to be detected and/or trigger specific operations such as a trigger signal 801. An example of trigger event could be the opening of a door, a motion detected, a loud noise or glass breaking, a smoke alarm detection, a water, flood detection, and/or other events or combinations thereof. The trigger signal 801 can then be sent to a computing device 810. The computing device 810 in at least one embodiment, can be an alarm panel. The computing device 810 can then analyze the trigger signal 803. During the analysis, the computing device 810 can determine if the trigger signal is a high, medium, or low priority trigger signal. For example, when the alarm monitoring system 800A is in an away, engaged and/or active mode most trigger signals may be analyzed as a high priority trigger signal. However, the alarm monitoring system 800A may be in a home, or local mode that prevents a trigger signal for causing a dispatch without a lengthy time period or a user authorization. If the computing device 810 determines that the trigger signal should be escalated, and/or sent to a receiving or monitoring station, the computing device 810 can create a notice signal 805.

The created noticed signal 805 may be intercepted by a conversion unit 820. The conversion unit 820 can then convert the notice signal 807 into a text or SMS message. The cost to send a test or SMS message is significantly less (approximately 1/12) the cost to send a tone signal over a landline or cellular network. The notice signal (converted notice signal) may thing be transmitted 809, over a transmission service 830. In at least one example, the transmission service 830 is a cellular or internet protocol network. A notice signal transmitted message and/or signal 811 may be provided to the computing device 810. The notice signal transmitted message or signal 811 can allow, in at least one example, for an alarm to be silenced and/or activated. In at least one embodiment, a monitoring station 870 can receive the notice signal 813. The monitoring station 870 may have a second conversion unit 820 to convert the text or SMS message into a DTMF tone signal for processing and/or routing by the monitoring station 870.

For example, the monitoring station 870 may send a transmission received message 815A, an alert user message 817, and/or allow for a dispatch action 819 from a dispatch station 880. The transmission received 815A may be transmitted by a transmission service 830 to the computing device 810 that may also acknowledge and/or trigger an action in response. The alert user message 817 may have a corresponding user alert notification 821 on a user's device 840. In at least one example, the user alert notification 821 may allow a user to respond to trigger a dispatch action 819, and/or some action message 823A. The action message 823A may cause an action and/or mode change 823B at the computing device 810. It would be understood that action message 823A, may be transmitted through the transmission service 830 and/or monitoring station 870. With the action and/or mode change 823B occurs a sensor action 825 may also be triggered.

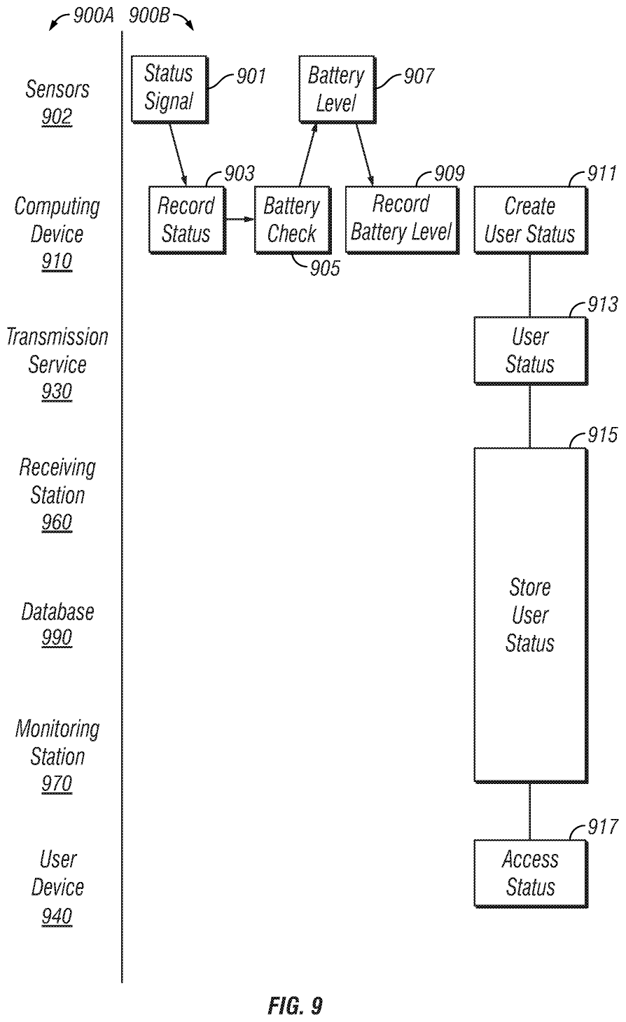

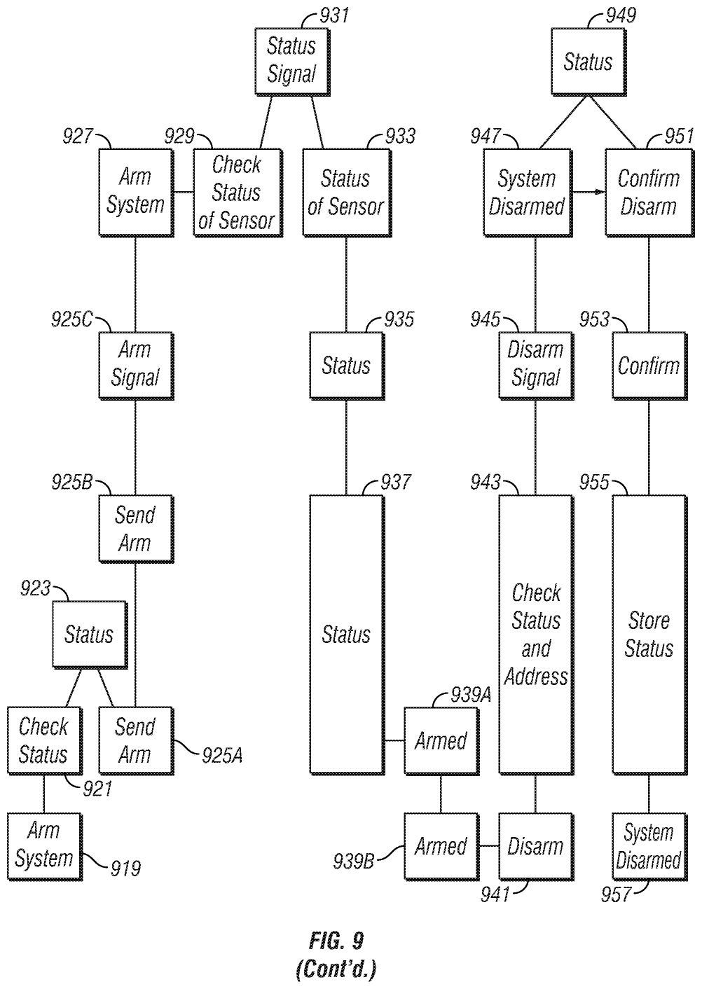

FIG. 9 is a flowchart illustration of an alarm monitoring system 900A and alarm monitoring signal chain 900B. The alarm monitoring system 900A may include a computing device 910 that is coupled to one or more sensors 902. In at least one embodiment, the computing device 910 is configured as an alarm panel that is coupled to the one or more sensors 902 by a wired or wireless connections.

A status signal 901 may be created by each of the one or more sensors 902. The status signal 901 can be a battery level, a mode status, a current status of the sensor 902, and/or other signals that allow for information about and/or provided by the sensors 902 to be sent to other devices. For example, a computing device 910, configured as an alarm panel, can receiving the sensor signal 901 and record the status 903 in a memory or storage unit (not illustrated) coupled to the computing device 910. The computing device may also send specific status requests to the one or more sensors 902, such as but not limited to a battery check requests 905. The one or more sensors 902 can then perform a battery check, or other specific sensor check 907, and send a return specific status signal to the computing device 910 that may then record the specific status 909 in a memory and/or storage unit (not illustrated).

A user status can be created 911 to allow for information regarding the alarm monitoring system 900A can be provided to one or more devices. For example, the created user status 913 may include the operating mode of the computing device 910 and/or one or more sensors 902. The user status 913 can be transmitted via a transmission service 930 to a receiving station 960, a database 990, a monitoring station 970, and/or a user device 940. In at least one example, the user status 913 can be stored 915 in a database 990 by the stations or other devices. By storing the user status 913 in a database 990 it allows multiple devices and/or stations to access the information 917. In at least one embodiment, the computing device 910 can send the user status 913 over a transmission service 930 to the database 990, allowing the user device 940, monitoring station 970 and/or receiving station 960 to access it.

In at least one embodiment, the receiving station 960 may be a regional and/or local station for receiving signals and/or working with local dispatch, law enforcement, or emergency personnel. Additionally, the monitoring station 970 may send and receive signals from the receiving station 960 and/or user device(s) 940. For example, a user may send an arm system request 919 that is received by the monitoring station 970. The monitoring station 970 checks the status of the computing device 910 921. In at least one example, the status 923 is stored in a database 990 that may be accessed by the stations or other devices. If the status 923 indicates that the computing device 910 is not armed then a send arm system message can be created 925A, and/or sent 925B via the monitoring station 970 and the receiving station 960. In some examples, the arm signal 925C can be converted by the monitoring station 970 and/or receiving station 960, and transmitted over a transmission service 930. Upon receiving the arm signal 925C, the computing device 910 can set its mode of operation to arm or armed 927. In at least one example, the computing device 910 also creates a status check signal 929 that is send to the one or more sensors 902.

For example, one of the sensors 902 may be in a position that would cause the system to be alerted under normal armed conditions but the system determines that the sensor 902 is in a specific position it can ignore and/or flag the sensor for later changes to the sensor 902 status. The one or more sensor(s) 902 create a status signal 931 that is transmitted to the computing device 910 which stores and/or records the sensor statuses 933. The computing device 910 may then transmit a system status 935 over a transmission service 930. In at least one example, the system status 935 may be received by the receiving station 960, monitoring station 970, and/or database 990. The system status 935 may then be accessed from any number of devices or stations. In at least one embodiment, an armed status 939A may be recorded by the monitoring station 970 and then provided as an armed status 939B to a user's device 940. A user may then provide a disarm message 941 to the monitoring station 970. In at least one example, the user device 940 may communicate with the database 990, monitoring station 970, and/or the receiving station 960. In some examples, the user device 940 may also be capable of communicating with the computing device 910. The monitoring station 970 and/or receiving station 960 may retrieve from the database(s) 990 the current status, check the status and create a disarm message 943. The disarm message or signal 945 can then be transmitted by a transmission service 930 to the computing device 910. The computing device 910 can after receiving the disarm message or signal 945, disarm the system 947. In at least one embodiment, a sensor status update 949 may be generated to allow the sensors 902 to change their mode of operations. The computing device 910 and/or sensors 902 may then create and/or provide a message or signal confirming disarm 951. The confirmation message or signal 953 can be transmitted over a transmission service 930. The stations 960 and/or 970, and/or database 990 can be updated and/or store the status 955 of the confirmation message 953. In at least one embodiment, the confirmation message 953 is provide to the user device 940 as a notification or message 957. In at least one example, the user device may receive messages, signals, and/or notifications in the form of text, SMS, email, and/or push notifications from an application running on the user device.

The present disclosure may include a computing device that can include any of an application specific integrated circuit (ASIC), a microprocessor, a microcontroller, a digital signal processor (DSP), a field-programmable gate array (FPGA), or equivalent discrete or integrated logic circuitry. In some examples, the system may include multiple components, such as any combination of one or more microprocessors, one or more microcontrollers, one or more DSPs, one or more ASICs, or one or more FPGAs. It would also be understood that multiples of the circuits, processors, or controllers could be used in combination or in tandem, or multithreading.

The components of the present disclosure may include any discrete and/or integrated electronic circuit components that implement analog and/or digital circuits capable of producing the functions attributed to the modules herein. For example, the components may include analog circuits, e.g., amplification circuits, filtering circuits, and/or other signal conditioning circuits. The components may also include digital circuits, e.g., combinational or sequential logic circuits, memory devices, etc. Furthermore, the modules may comprise memory that may include computer-readable instructions that, when executed cause the modules to perform various functions attributed to the modules herein.

Memory may include any volatile, non-volatile, magnetic, or electrical media, such as a random access memory (RAM), dynamic random access memory (DRAM), static random access memory (SRAM), read-only memory (ROM), non-volatile RAM (NVRAM), electrically-erasable programmable ROM (EEPROM), flash memory, hard disks, or any other digital media. Additionally, there may also be a tangible non-transitory computer readable medium that contains machine instructions, such as, a (portable or internally installed) hard drive disc, a flash drive, a compact disc, a DVD, a zip drive, a floppy disc, optical medium, magnetic medium, or any other number of possible drives or discs, that are executed by the internal logic of a computing device. It would be understood that the tangible non-transitory computer readable medium could also be considered a form of memory or storage media.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. A system for Dual Tone Multi-Frequency (DTMF) signal transformation at a sending location comprising:
at least one sensor at the sending locatior capable of producing at least one trigger signal,
at least one communication network capable of transmitting the at least one trigger signal from the at least one sensor;
at least one computing device coupled to the at least one communication network at the sending location and the at least one computing device capable of receiving the at least one trigger signal from the at least one sensor over the at least one communication network;
wherein the at least one computing device is configured to create a DTMF notice signal for transmission over a first transmission service; and
a conversion unit coupled between the at least one computing device and the at least one transmission service unit, the conversion unit configured to intercept the DTMF notice signal, and convert it into a notice signal which is a text version of the DTMF notice signal, and transmit it via the at least one transmission service unit via a second transmission service.

2. The system of claim 1, wherein the at least one transmission service is chosen from: a cellular voice or data transmission service, an internet protocol transmission service or a landline transmission service.

3. The system of claim 1, wherein the at least one communication network includes a wireless network.

4. The system of claim 1, wherein the at least one communication network includes a wired network.

5. The system of claim 1, wherein the at least one computing device analyzes the at least one trigger signal before creating the notice signal.

6. (canceled)

7. (canceled)

8. The system of claim 1, wherein a Short Messaging System (SMS) message is created by the conversion unit from the DTMF signal, and the SMS message becomes the notice signal transmitted to the receiving station.

9. A method for Dual Tone Multi-Frequency (DTMF) signal transformation comprising;
monitoring at least one sensor at a sending location via a communication network;
detecting a trigger signal from the at least one sensor with a computing device, at the sending location, coupled to the communication network;
creating a DTMF notice signal configured for transmission via a first transmission service with the computing device at the sending location;
intercepting the DTMF notice signal with a conversion unit coupled between the computing device and a transmission service unit, wherein thy conversion unit converts the DTMF notice signal into a notice signal;
transmitting the notice signal to a receiving station at a distal location using second transmission service; and
wherein when the notice signal is received at the receiving station it is converted back into the DTMF notice signal for use by the receiving station;
wherein the notice signal is transmitted as text via the at least one transmission service.

10. The method of claim 9, wherein the communication network is a wireless network.

11. The method of claim 9, wherein the communication network is a wired network.

12. The method of claim 9, wherein the at least one transmission service is chosen from: a cellular voice or data transmission service, an internet protocol transmission service or a landline transmission service.

13. The method of claim 9, wherein the detecting step further comprises analyzing the trigger signal io determine a priority level.

14. The method of claim 9, further comprising providing at least one status update from the at least one sensor.

15. The method of claim 14, wherein the at least one status update includes a battery level.

16. The method of claim 14, wherein the at least one status update includes alarm status signal.

17. The method of claim 9, further comprises forwarding the notice signal to a monitoring station.

18. A system for Dual Tone Multi-Frequency (DTMF) signal transformation comprising:
at least one receiving unit coupled to at least one transmission service at a receiving location;
at least one receiving computing device coupled to the at least one receiving unit at the receiving location;
at least one DTMF conversion unit coupled to the at least one sending computing device at a sending location, the at least one DTMF conversion unit configured for intercepting a DTMF notice signal transmitted from the at least one computing device at the sending location, and converting the DTMF notice signal into a notice signal that is a text version of the DTMF notice signal;
at least one text to DTMF conversion unit coupled to at least one receiving unit at the receiving location;
wherein the at least one text to DTMF conversion unit is utilized to convert a notice signal received by the at least one receiving unit as text into the DTMF notice signal, and the at least one receiving computing device evaluates the DTMF notice signal for the proper action based on a priority level or a set of DTMF notice signal rules.

19. The system of claim 18, wherein the at least one transmission service is chosen from: a cellular voice or data transmission service, an internet protocol transmission service or a landline transmission service.

20. The system of claim 18, wherein the DTMF conversion unit is further coupled to the at least one transmission service.

21. The system of claim 18, wherein an alert signal is send to a dispatch station via the at least one transmission service.
